(19) United States
(12) Patent Application Publication
(10) Pub. No.: US 2005/0136733 A1
(43) Pub. Date: Jun. 23, 2005

(54) Remote high voltage splitter block

(76) Inventors: Brian E. Gorrell, Fremont, IN (US); David M. Seitz, Riga, MI (US)

Correspondence Address: BARNES & THORNBURG, 11 SOUTH MERIDIAN, INDIANAPOLIS, IN, 46204, US

(21) Appl. No.: 10/743,203

(22) Filed: Dec. 22, 2003

(51) Int. Cl. H01R 11/00

(52) U.S. Cl. 439/502

(57) ABSTRACT

A distribution device is provided for distributing high magnitude electrical potential from an input port of the distribution device to a plurality of output ports thereof. The distribution device includes a first portion and a second portion adapted for engagement. At least one of the first and second portions includes cooperating couplers providing electrical continuity between the distribution device input port and the plurality of distribution device output ports. The distribution device can be incorporated into a high magnitude potential supply system including a high magnitude potential supply having an output port at which a high magnitude potential is provided. The system further includes utilization devices. The output port of the high magnitude potential supply is coupled to the distribution device input port. Respective output ports of the distribution device are coupled to respective utilization devices.

### FIELD OF THE INVENTION

This invention relates to the distribution of high magnitude electrical potential from power supplies to utilization devices. It is disclosed in the context of distribution of high magnitude electrical potential from a power supply to devices for the electrostatically aided atomization and dispensing of coating materials. However, it is believed to be useful in other applications as well.

### BACKGROUND OF THE INVENTION

Various types of power supplies are known. There are, for example, the disclosures of the following U.S. Pat. Nos. 2,767,359; 3,273,015; 3,627,661; 3,641,971; 3,731,145; 3,764,883; 3,795,839; 3,809,955; 3,851,618; 3,872,370; 3,875,892; 3,893,006; 3,894,272; 3,895,262; 3,970,920; 4,000,443; 4,038,593; 4,073,002; 4,075,677; 4,182,490; 4,187,527; 4,196,465; 4,266,262; 4,287,552; 4,323,947; 4,324,812; 4,343,828; 4,353,970; 4,377,838; 4,385,340; 4,402,030; 4,409,635; 4,472,781; 4,481,557; 4,485,427; 4,508,276; 4,538,231; 4,587,605; 4,630,220; 4,651,264; 4,672,500; 4,674,003; 4,698,517; 4,710,849; 4,737,887; 4,745,520; 4,764,393; 4,797,833; 4,809,127; 4,825,028; 4,841,425; 4,890,190; 4,891,743; 4,912,588; 4,916,571; 4,920,246; 5,012,058; 5,019,996; 5,056,720; 5,063,350; 5,067,434; 5,080,289; 5,093,625; 5,107,438; 5,121,884; 5,124,905; 5,138,513; 5,159,544; 5,222,663; 5,267,138; 5,340,289; 5,351,903; 5,433,387; 5,457,621; 5,566,042; 5,666,279; 5,745,358; 5,818,709; 5,939,993; 5,947,377; 5,978,244; 6,144,570; and, 6,423,142. There are also the disclosures of the following published foreign patents and applications: DE 24 36 142; DE 32 15 644; EP 0 160 179; and, GB 2 077 006. There are also the disclosures of Rans-Pak 1000™ Power Supply, May, 1990; Rans-Pak 1000™ Power Supply, 1991; Rans-Pak 100™ Power Supply, May, 1988; Rans-Pak 300™ Power Supply, Sep., 1990; Ransburg GEMA Series 400 Power Supply Panel Service Manual, April, 1990; and, Kazkaz, Electric Field and Space Charge of Spherical Electrode at High Voltage Concentric with a Spherical Grounded Conductive Target: Proc. at the 1996 Industry Applications Society 31 st Annual Mtg., San Diego, Calif., 1904-1911 (October 1996). The disclosures of the references cited herein are hereby incorporated herein by reference. Listing of the references cited herein is not intended to be a representation that a complete search of all relevant art has been made, or that no more pertinent art than that listed exists, or that the listed art is material to patentability. Nor should any such representation be inferred.

### DISCLOSURE OF THE INVENTION

According to an aspect of the invention, a distribution device is provided for distributing high magnitude electrical potential from an input port of the distribution device to a plurality of output ports thereof. The distribution device includes a first portion and a second portion adapted for engagement. At least one of the first and second portions includes cooperating couplers providing electrical continuity between the input port and the plurality of output ports.

Illustratively according to this aspect of the invention, the cooperating couplers comprise high voltage contacts. The at least one of the first and second portions includes openings for receiving the high voltage contacts.

Illustratively according to this aspect of the invention, the at least one of the first and second portions and the couplers include complementary threaded portions for securing the couplers in engagement with the at least one of the first and second portions.

Further illustratively according to this aspect of the invention, the apparatus comprises a plug including a complementary threaded portion for securing the plug in the at least one of the first and second portions. The plug is adapted to be received in at least one of the openings to replace an unused one of the couplers.

Illustratively according to this aspect of the invention, the first and second portions include complementary threaded portions for securing the first and second portions together in assembled configuration.

Illustratively according to this aspect of the invention, the first and second portions include complementary surfaces between which at least one of the cooperating couplers is captured to promote electrical continuity among the cooperating couplers through the device.

Illustratively according to this aspect of the invention, the complementary surfaces include labyrinthine portions in order that the surface distance from the complementary surfaces to an outer surface of the device may be increased.

Further illustratively according to this aspect of the invention, the apparatus includes a high magnitude potential supply having an output port at which a high magnitude potential is provided, and a plurality of high magnitude potential utilization devices. The output port of the high magnitude potential supply is coupled to the input port of the distribution device. Respective output ports of the distribution device are coupled to respective utilization devices.

Illustratively according to this aspect of the invention, the utilization devices comprise coating material atomizing and dispensing devices.

Illustratively according to this aspect of the invention, the coating material atomizing and dispensing devices comprise electrostatically aided coating material atomizing and dispensing devices.

Further illustratively according to this aspect of the invention, the apparatus includes at least one coating material source coupled to the coating material atomizing and dispensing devices.

According to another aspect of the invention, a high magnitude potential supply system includes a high magnitude potential supply having an output port at which a high magnitude potential is provided. The high magnitude potential supply system further includes a high magnitude potential distribution device having an input port and output ports. The system further includes utilization devices. The output port of the high magnitude potential supply is coupled to the input port of the distribution device. Respective output ports of the distribution device are coupled to respective utilization devices.

Illustratively according to this aspect of the invention, the utilization devices comprise coating material atomizing and dispensing devices.

Illustratively according to this aspect of the invention, the coating material atomizing and dispensing devices comprise electrostatically aided coating material atomizing and dispensing devices.

Further illustratively according to this aspect of the invention, the apparatus includes at least one coating material source coupled to the coating material atomizing and dispensing devices.

### BRIEF DESCRIPTION OF THE DRAWINGS

The invention may best be understood by referring to the following detailed description and accompanying drawings which illustrate the invention. In the drawings:

FIGS. 1-3 illustrate partly block and partly schematic diagrams of certain prior art high magnitude potential distribution systems;

FIG. 4 illustrates a partly block and partly schematic diagram of a high magnitude potential distribution system constructed according to the present invention;

FIG. 5 illustrates an end view of a detail of the system illustrated in FIG. 4, taken generally along section lines 5-5 of FIG. 4;

FIG. 6 illustrates a sectional view of the detail illustrated in FIG. 5, taken generally along section lines 6-6 of FIG. 5; and,

FIG. 7 illustrates a sectional view of the detail illustrated in FIGS. 4-5, taken generally along section lines 7-7 of FIG. 6.

### DETAILED DESCRIPTION OF ILLUSTRATIVE EMBODIMENTS

As used herein, terms such as “electrically conductive” and “electrically non-insulative” refer to a broad range of conductivities electrically more conductive than materials described as “electrically non-conductive” and “electrically insulative.” Terms such as “electrically semiconductive” refer to a broad range of conductivities between electrically conductive and electrically non-conductive.

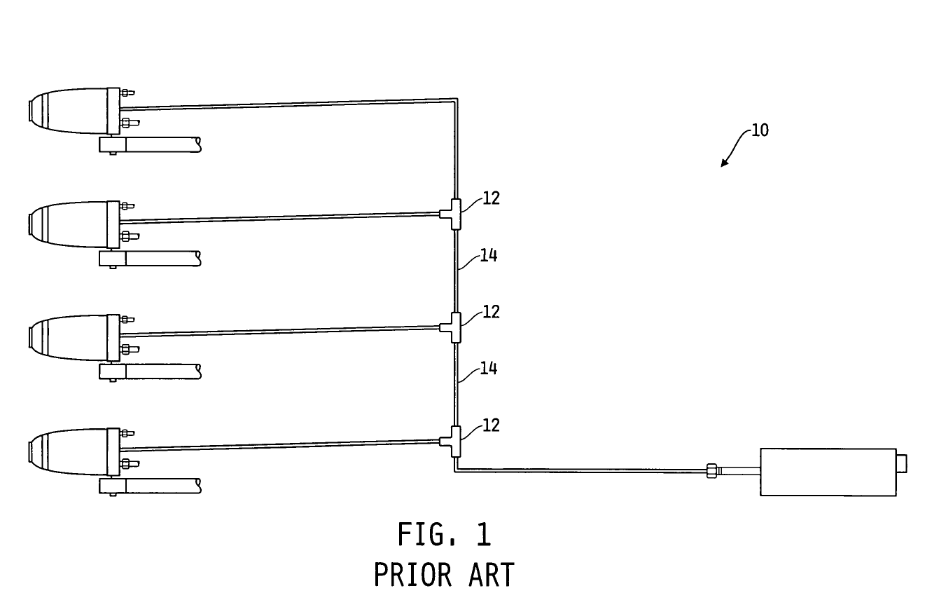

Referring to FIG. 1, some prior art high magnitude potential distribution systems 10 include high voltage Tee connectors 12 which can be daisy chained from one to another via lengths 14 of high voltage cable. Such Tee connectors 12 typically must be isolated from reference potentials, such as earth ground, to prevent leakage of high magnitude potential from them to reference potential.

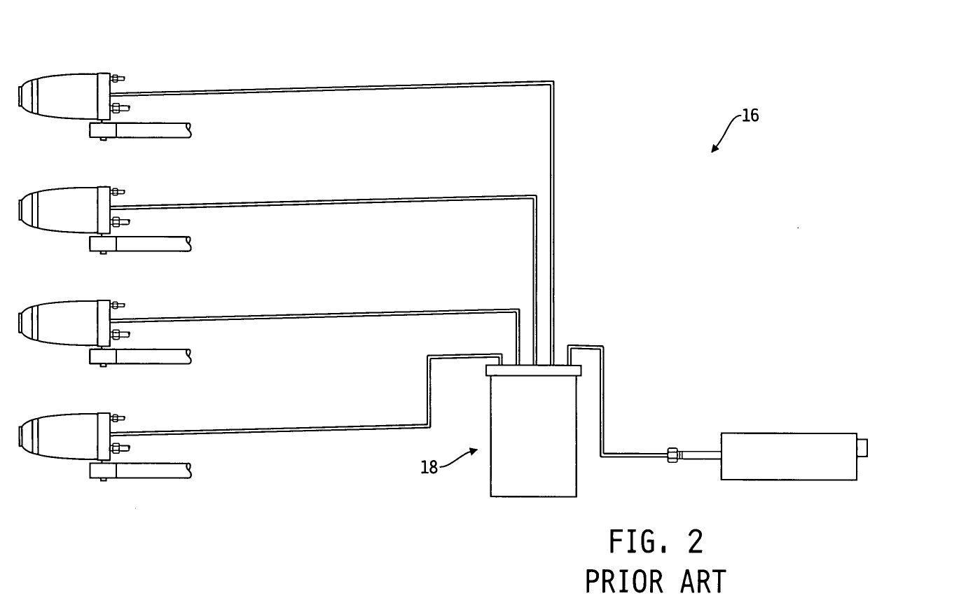

Referring to FIG. 2, other prior art high magnitude potential distribution systems 16 include dielectric fluid filled tanks 18. Such tanks 18 are typically relatively heavy and occupy relatively more space than other prior art systems. Further, in many circumstances, dielectric fluids from such dielectric fluid filled tanks 18 require special handling.

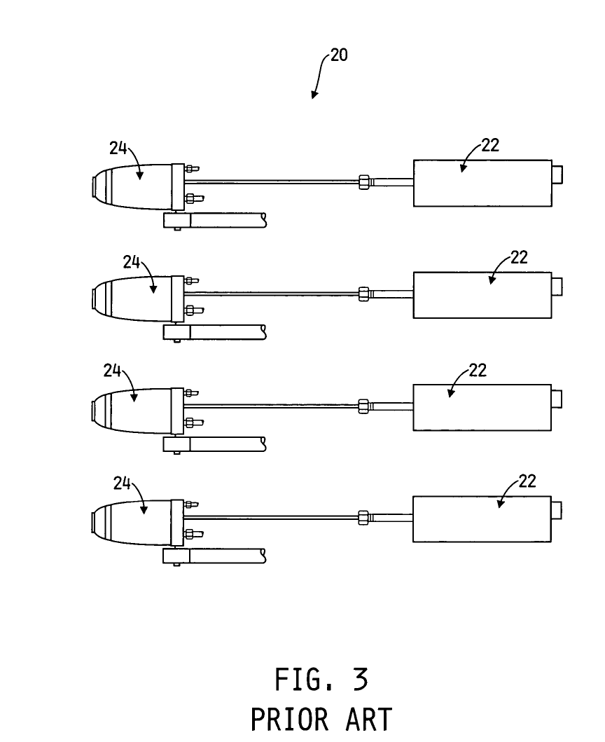

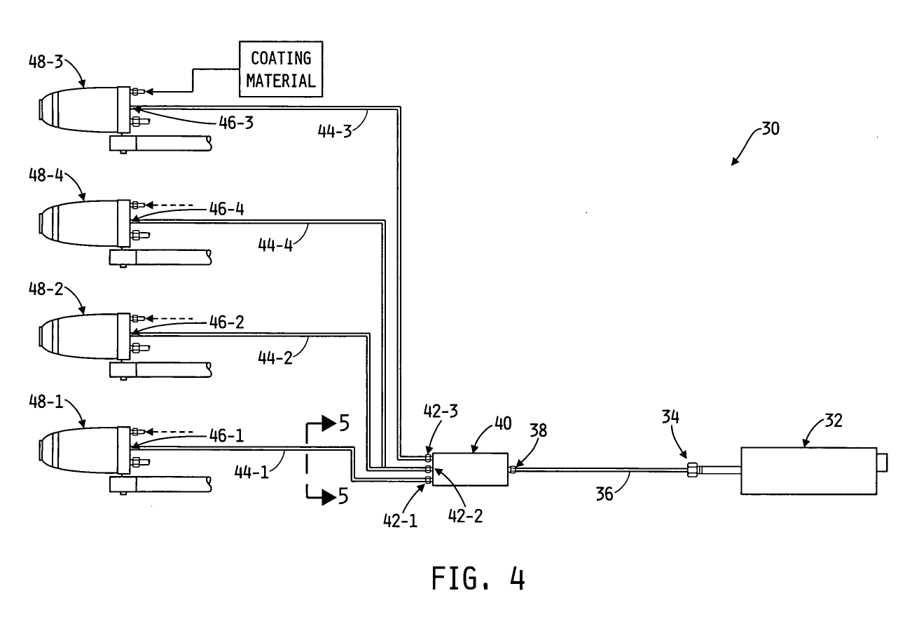

In still other distribution systems 20, a high magnitude potential supply 22 is required for each utilization device 24. This entirely avoids the problem of distribution from a single high magnitude potential supply 22 to multiple utilization devices 24, such as, for example, coating material atomizing and dispensing equipment of the general type described in U.S. Pat. Nos. 5,433,387; 5,622,563; 5,632,448; 5,633,306; 5,662,278; 5,853,126; 5,957,395; 6,076,751; 6,230,993; 6,328,224, the disclosures of which are hereby incorporated herein by reference. However, it is typically expensive in that it requires a high magnitude potential supply 22 for each utilization device 24. Such a system 20 is illustrated in FIG. 3.

A high magnitude potential supply system 30 constructed according to the invention includes a high magnitude potential supply 32, such as, for example, one of the general type illustrated and described in U.S. Pat. Nos. 5,138,513; 5,159,544; 5,978,244; 6,144,570; 6,423,142, the disclosures of which are hereby incorporated herein by reference. The high magnitude potential supply 32 includes an output port 34 at which a high magnitude potential, such as, for example, −100 KV, is provided. The output port 34 is coupled through a length 36 of high voltage cable to an input port 38 of a high magnitude potential distribution device 40. Distribution device 40 includes a number, illustratively four, of output ports 42-1, 42-2, . . . 42-n, each of which is adapted to be coupled through a respective length 44-1, 44-2, . . . 44-n of high voltage cable 44 to an input port 46-1, 46-2, . . . 46-n of a respective utilization device 48-1, 48-2, . . . 48-n, such as one of the coating material atomizers identified above.

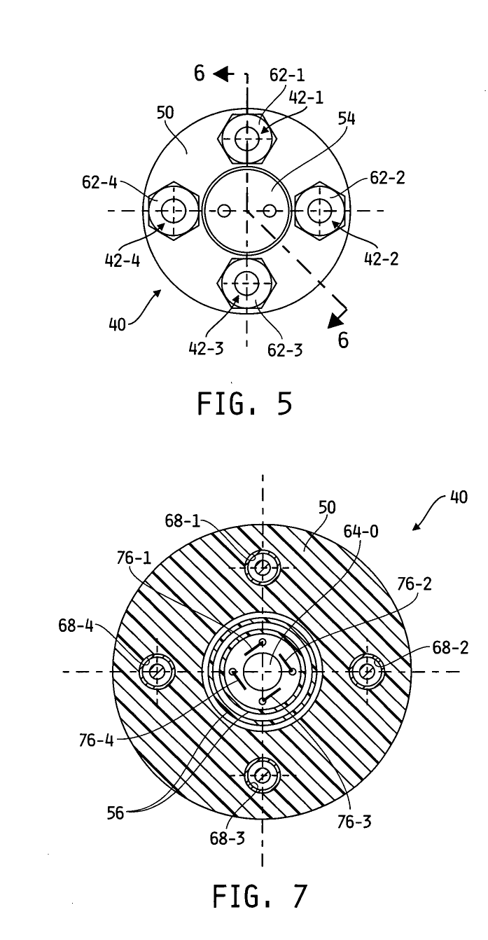

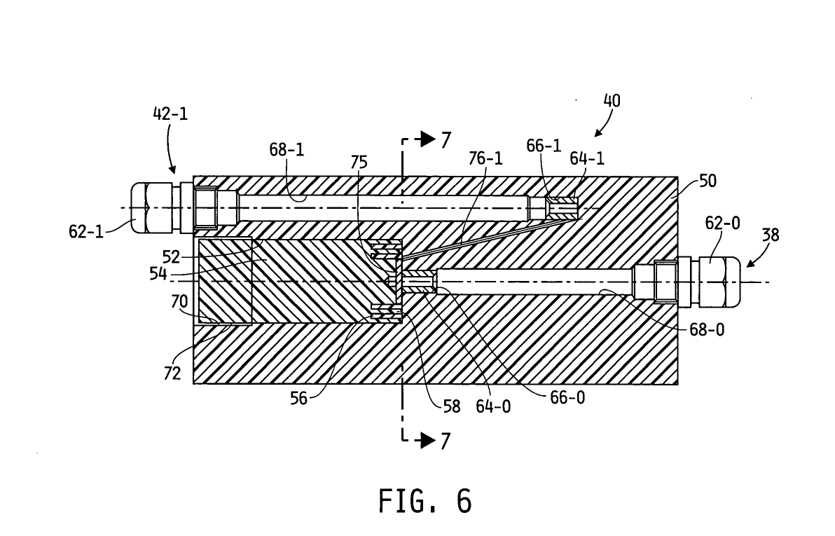

Referring now particularly to FIGS. 5-7, distribution device 40 includes a first portion 50. Portion 50 includes a central passageway 52 for receiving a second portion 54. Portions 50, 54 are constructed from suitable electrically non-conductive materials, such as certain polytetrafluoroethylenes, polymethylmethacrylates, acetal resins, and the like. Mating regions of portions 50, 54 are provided with complementary surfaces 56, 58, respectively, including labyrinthine portions in order that the surface distance from the centers of surfaces 56, 58 to the outer surface 60 of device 40 may be made greater. Input port 38 and output ports 42-1, 42-2, 42-3, 42-4 are provided by fittings 62-0, 62-1, 62-2, 62-3, 62-4, respectively. High voltage jacks 64-0, 64-1, 64-2, 64-3, 64-4 are press fitted into cavities 66-0, 66-1, 66-2, 66-3, 66-4, respectively, provided therefor at the ends of passageways 68-0, 68-1, 68-2, 68-3, 68-4, respectively, provided in portions 50 and 54 for fittings 62-0, 62-1, 62-2, 62-3, 62-4. Fittings 62-0, 62-1, 62-2, 62-3, 62-4 are threaded into respective ones of these jacks 64-0, 64-1, 64-2, 64-3, 64-4. Portions 50, 54 also include complementary threaded portions 70, 72 so that surfaces 56, 58 can be brought into contact. Typically, a suitable dielectric grease will be placed on one or both of surfaces 56, 58 to reduce the likelihood of discharge from fittings or jacks to atmosphere between portions 50, 54.

A conductive disk 75 is placed at the end of passageway 52 and captured there between portions 50, 54 in the assembled device. One end of each conductor 76-1, 76-2, 76-3, 76-4 is inserted through a respective passageway provided therefor in portion 50 from passageway 52 to a respective cavity 66-1, 66-2, 66-3, 66-4. Installation of jacks 64-1, 64-2, 64-3, 64-4 into cavities 66-0, 66-1, 66-2, 66-3, 66-4, respectively, causes contact to be established between conductors 76-1, 76-2, 76-3, 76-4 and jacks 64-1, 64-2, 64-3, 64-4, respectively. The remaining end of each conductor 76-1, 76-2, 76-3, 76-4 is pressed into electrically conductive contact with disk 75 in the assembled device 40 to promote electrical continuity between disk 75 and conductors 76-1, 76-2, 76-3, 76-4.

The high magnitude potential distribution device 40 permits distribution of high magnitude potential for a number, illustratively, four, of utilization devices 48-1, 48-2, . . . 48-n, for example, electrostatically aided coating material atomizers, from a single high magnitude potential source 32 output port 34. The distribution device 40 can be located remotely from the high magnitude potential source 32. Coupling of the high magnitude potential source 32 to the distribution device 40 can be made via high voltage cable 36. The distribution device 40 can be of relatively small, lightweight construction. The distribution device 40 can be mounted in locations close to much lower magnitude potentials, for example, ground, owing to its insulating properties. Any unused output port(s) 42-1, 42-2, . . . 42-n of the distribution device 40 which is (are) not needed can be plugged by (a) plug(s) having the same shape as the fittings 62-1, 62-2, 62-3, 62-4, but including no conductive portions, permitting the distribution device 40 to distribute high magnitude potential to fewer than n utilization devices 48. Again, typically, a suitable dielectric grease will be placed on the outer surface(s) of such (a) plug(s) before the plug(s) is (are) threaded into portion 50 to reduce the likelihood of discharge to atmosphere between portion 50 and the plug(s). Illustratively, the output ports 42-1, 42-2, . . . 42-n of the distribution device 40 accept, for example, a banana type connector.

1. A distribution device for distributing high magnitude electrical potential from an input port of the distribution device to a plurality of output ports thereof, the distribution device including a first portion and a second portion adapted for engagement, at least one of the first and second portions including cooperating couplers.

2. The apparatus of claim 1 wherein the cooperating couplers comprise high voltage contacts, the at least one of the first and second portions including openings for receiving the high voltage contacts.

3. The apparatus of claim 1 wherein the at least one of the first and second portions and the couplers include complementary threaded portions for securing the couplers in engagement with the at least one of the first and second portions.

4. The apparatus of claim 3 further comprising a plug including a complementary threaded portion for securing the plug in the at least one of the first and second portions, the plug adapted to be received in at least one of the openings to replace an unused one of the couplers.

5. The apparatus of claim 1 wherein the first and second portions include complementary threaded portions for securing the first and second portions together in assembled configuration.

6. The apparatus of claim 1 wherein the first and second portions include complementary surfaces between which at least one of the cooperating couplers is captured to promote electrical continuity among the cooperating couplers through the device.

7. The apparatus of claim 6 wherein the complementary surfaces include labyrinthine portions.

8. The apparatus of claim 1 further including a high magnitude potential supply having an output port at which a high magnitude potential is provided, and a plurality of high magnitude potential utilization device, the output port of the high magnitude potential supply being coupled to the input port of the distribution device and respective output ports of the distribution device being coupled to respective utilization devices.

9. The apparatus of claim 8 wherein the utilization devices comprise coating material atomizing and dispensing devices.

10. The apparatus of claim 9 wherein the coating material atomizing and dispensing devices comprise electrostatically aided coating material atomizing and dispensing devices.

11. The apparatus of claim 9 further including at least one coating material source coupled to the coating material atomizing and dispensing devices.

12. A high magnitude potential supply system including a high magnitude potential supply having an output port at which a high magnitude potential is provided, a high magnitude potential distribution device having an input port and output ports, utilization devices, the output port of the high magnitude potential supply being coupled to the input port of the distribution device and respective output ports of the distribution device being coupled to respective utilization devices.

13. The apparatus of claim 12 wherein the utilization devices comprise coating material atomizing and dispensing devices.

14. The apparatus of claim 13 wherein the coating material atomizing and dispensing devices comprise electrostatically aided coating material atomizing and dispensing devices.

15. The apparatus of claim 13 further including at least one coating material source coupled to the coating material atomizing and dispensing devices.
